(19) United States
(12) Patent Application Publication
(10) Pub. No.: US 2024/0078907 A1
(43) Pub. Date: Mar. 7, 2024

(54) Method for Decreasing a Transmission Frequency of Messages of a Vehicle

(71) Applicant: Robert Bosch GmbH, Stuttgart (DE)

(72) Inventors: Andreas Wienss, Eningen Unter Achalm (DE); Peter Matt, Salmendingen (DE)

(21) Appl. No.: 18/455,157

(22) Filed: Aug. 24, 2023

(30) Foreign Application Priority Data
Sep. 7, 2022 (DE) 10 2022 209 276.7

(51) Int. Cl. G08G 1/16

(52) U.S. Cl. CPC G08G 1/161

(57) ABSTRACT

A method for sending messages from a vehicle to a receiver during travel by the vehicle is disclosed. The method includes (i) estimating a first future trajectory of the vehicle, (ii) sending trajectory information about the first trajectory to the receiver, (iii) determining a deviation of an actual position of the vehicle from a position predicted by the first trajectory, (iv) estimating a second future trajectory, and (v) sending trajectory information about the second trajectory to the receiver if the deviation is greater than a threshold value.

This application claims priority under 35 U.S.C. § 119 to patent application no. DE 10 2022 209 276.7, filed on Sep. 7, 2022 in Germany, the disclosure of which is incorporated herein by reference in its entirety.

The disclosure relates to a method for decreasing a transmission frequency of messages of a vehicle to a receiver during travel by the vehicle.

The disclosure further relates to a vehicle designed to send messages to a receiver during travel.

### BACKGROUND

Vehicles in traffic can send their current location and speed to other road users. The road users can compare their position to the position of the vehicle so that a collision hazard is reduced.

Given that the position and speed of the vehicle is sent periodically, a high bandwidth is required.

It has become known from WO 2018/202601 A1 to send information about the status, e.g., the position, direction, and speed of a vehicle to other road users. This information enables other road users to calculate the expected route of the vehicle. As long as the status of the vehicle corresponds to the expected status, it will not send any further information to the other road users. On the other hand, if the status of the vehicle changes, e.g., at a timepoint when the speed is less than predicted, then the vehicle transmits an updated status to the road users. In this way, the necessary transmission frequency for the status information is reduced.

The information about the status is used by the other road users to determine predictions about the route of the aforementioned vehicle. For this prediction of the route from the transmitted status (position, direction, speed), calculation rules are used which are based on certain assumptions, for example with regard to filtering or using the history. If these assumptions differ on the sender and receiver side, the route of the vehicle expected by road users can be different from the route of the vehicle expected by the vehicle. In addition, regular travel involves regular changes, e.g. steering or braking maneuvers, that cannot be correctly described using only a few status parameters, so an update of the status often needs to be sent.

### SUMMARY

In one embodiment, the present disclosure provides a method for sending messages from a vehicle to a receiver during travel by the vehicle, comprising the following steps:
estimating a first future trajectory of the vehicle,
sending trajectory information about the first trajectory to the receiver,
determining a deviation of an actual position of the vehicle from a position predicted by the first trajectory,
estimating a second future trajectory, and
sending trajectory information about the second trajectory to the receiver if the deviation is greater than a threshold value.

In one embodiment, the present disclosure provides a vehicle designed to send messages to a receiver during travel, said vehicle comprising:
a first estimation device designed to estimate a first trajectory of the vehicle,
a first sending device designed to send trajectory information about the first trajectory to a receiver,
a determination device designed to determine a deviation of an actual position of the vehicle from a position predicted by the first trajectory,
a second estimation device designed to estimate a second future trajectory, and
a second sending device designed to send trajectory information about the second trajectory to the receiver if the deviation is greater than a threshold value.

Possible advantages achieved in particular by sending the trajectory information immediately, include (among others):
Given that trajectory information can describe more complex maneuvers than pure status information reflecting position, direction and speed, the messages can be sent at a lower frequency, so less bandwidth is needed.
No (potentially error-prone) coordination is required between the transmitter and the receiver with respect to the calculation rules about how a trajectory can be estimated based on the status information. Both the transmitter and the receiver are therefore expecting the same trajectory. Doing so minimizes the risk of incorrect estimates of a collision probability.

In particular in the claims and preferably in the description, the term “trajectory” is understood in the broadest sense as related to the terms “sending,” “transmitting,” or the like regarding any information about the trajectory of a vehicle.

Further features, advantages, and additional embodiments of the disclosure are described hereinafter or will be made obvious thereby.

According to an advantageous embodiment of the disclosure, the trajectory information about the first and/or second trajectory comprises information about at least one possible future waypoint at which the vehicle can be located at least at one specific future timepoint. In particular, one or multiple possible waypoints are indicated where the vehicle can be located at the various timepoints. The advantage of doing so is that, based on the transmitted information about the trajectory, the expected route of the vehicle can be at least estimated.

According to one advantageous embodiment of the disclosure, the trajectory information about the first and/or second trajectory comprises confidence information for at least a portion of the possible future waypoints. The confidence information is based on the probability that the vehicle will be located at a particular waypoint at a specific timepoint. In particular, confidence information is sent for each possible waypoint sent. One advantage of doing so is that the receiver can more reliably estimate or determine the probability that the vehicle will be at a specific waypoint.

According to an advantageous embodiment of the disclosure, the first and/or second trajectory is described using one or multiple polynomials. In particular, the polynomial can be a function of the possible future waypoints. An accurate trajectory can be efficiently transmitted thereby. The trajectory can be described either by individual polynomials, i.e., each in a X, Y, and/or Z direction, or by means of a single polynomial that describes multiple spatial directions.

According to an advantageous embodiment of the disclosure, the first and/or second trajectory comprises a tolerance range described by polynomials. The future trajectory may be subject to uncertainty. To represent this uncertainty, the trajectory can be provided with a tolerance range. The tolerance range can represent future waypoints that are located around the trajectory represented by the polynomial and where the vehicle will also be located with a high probability. It is also possible for multiple polynomials to be sent and a range enclosed by the polynomials defines all possible waypoints at which the vehicle will be able to be located such that this range corresponds to the expected tolerance range. In this way, the uncertainty of future waypoints can be efficiently represented to the receiver.

According to one advantageous embodiment of the disclosure, the tolerance range is calculated based on a statistical characteristic, in particular a standard deviation, of the future waypoints. Based on the tolerance range, the waypoints at which the vehicle will be located with a high probability can be determined. For example, the standard deviation can be used to determine those waypoints that are within the tolerance range. For example, the expected position distribution of the possible waypoints can be determined at a point in time. The tolerance range then corresponds to those waypoints that are within a multiple of the standard deviation of the expected position distribution. One advantage thereby is that the tolerance range can be determined in a simple manner.

According to an advantageous embodiment of the disclosure, determining a deviation is performed based on a comparison of the actual position of the vehicle with waypoints described by the tolerance range. The trajectory information is sent again when the vehicle deviates from the expected trajectory. The tolerance range can be used for this purpose. If the vehicle reaches a waypoint outside of the tolerance range, i.e., the actual position of the vehicle is different from the expected waypoints, then the trajectory is resent. The advantage thereby is that the transmission frequency of the trajectory information can be further reduced.

According to an advantageous embodiment of the disclosure, trajectory information about the second future trajectory is sent if more than a predefined period of time has elapsed since the trajectory information about the first trajectory was sent. The greater the amount of time since the trajectory information was last sent, the less accurate is a prediction of possible waypoints, as the vehicle can deviate from the original trajectory. In particular, the receiver does not have any trajectory information beyond the originally sent trajectory. By defining a maximum amount of time by which a re-trajectory is sent, a receiver can better estimate the trajectory of the vehicle.

According to an advantageous embodiment of the disclosure, trajectory information about the second future trajectory is sent when the second future trajectory deviates from the first future trajectory, in particular if it deviates from the first trajectory within a predefined period of time. It is possible that the vehicle can still be within the waypoints described by the first trajectory sent, but that the future second trajectory is already expected to be different from the first trajectory. In this case, the second trajectory can be sent early so that the receiver can be immediately informed of the new trajectory. Doing so is particularly useful if little time, e.g., less than 1000 milliseconds, in particular less than 500 milliseconds, preferably less than 300 milliseconds, has passed since sending the first trajectory, since a possible receiver in this case expects the vehicle to move based on the first trajectory.

According to one advantageous embodiment of the disclosure, information about future directions, speeds and/or accelerations of the vehicle is transmitted. Doing so enables the receiver to better avoid collisions with the vehicle.

According to one advantageous embodiment of the disclosure, the first and/or second trajectory is estimated based on a direction of the vehicle, an acceleration of the vehicle, a speed of the vehicle, a position of the vehicle, a yaw rate of the vehicle, dynamic models of the vehicle from map information, and/or at least one learning algorithm. The advantage thereby is that the trajectory can be estimated more accurately.

Further important features and advantages of the disclosure are set forth below and in the accompanying drawings.

It is understood that the features specified hereinabove and the features yet to be explained hereinafter can be used not only in the respectively specified combination, but also in other combinations, or alone, without departing from the scope of the present disclosure.

### BRIEF DESCRIPTION OF THE DRAWINGS

Preferred designs and embodiments of the present disclosure are illustrated in the drawings and explained in greater detail in the subsequent description.

Shown in schematic form are:

FIG. 1 steps of a method according to one embodiment of the present disclosure;

FIG. 2 a trajectory of a vehicle according to an embodiment of the present disclosure; and

FIG. 3 a vehicle according to one embodiment of the present disclosure.

### DETAILED DESCRIPTION

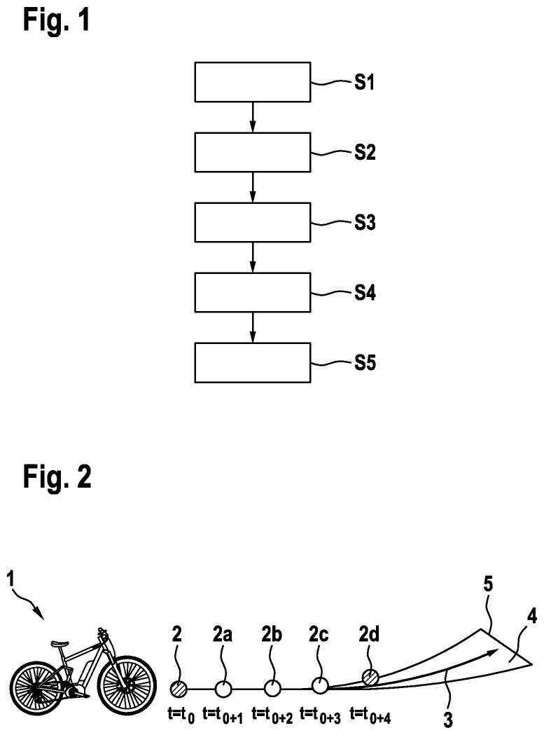

FIG. 1 shows in schematic form the steps of a method according to one embodiment of the present disclosure.

In a step S1, a first future trajectory of a vehicle is estimated. To this end, the position, speed, direction, and/or other information, e.g. map information, is used to estimate at which waypoints the vehicle will be located at specific timepoints.

The trajectory information about the first trajectory is sent to a receiver in a further step S2. The receiver thereby knows the trajectory expected of the vehicle. The receiver can on this basis, e.g., plan its own route in order to avoid a collision.

In a further step S3, a deviation of an actual position of the vehicle from a position predicted by the first trajectory is determined. After the vehicle sends a first trajectory, it checks whether it is in compliance with the expected trajectory sent. For example, it compares whether the current position is within a tolerance range of the trajectory.

In a further step S4, a second future trajectory of the vehicle is estimated. The second future trajectory can in particular be estimated as the vehicle moves away from the first trajectory.

In a step S5, trajectory information about the second trajectory is sent to the receiver if the deviation is greater than a threshold value. As long as the vehicle has only slightly moved away from the sent trajectory, the actual trajectory corresponds approximately to the trajectory expected by the receiver. Resending a trajectory is therefore not necessary because the second trajectory is only substantially the same trajectory as the first. In other words, the receiver already expects the vehicle to move along the second trajectory so that it does not contain any new information.

As soon as the vehicle moves away from the first trajectory, the deviation between the position of the vehicle and the first trajectory is consequently greater than a threshold value, the movement of the vehicle is no longer predictable by the receiver. In this case, the second new trajectory is sent to the receiver so that it can again predict the driving behavior of the vehicle.

FIG. 2 shows in schematic form a trajectory of a vehicle according to one embodiment of the present disclosure.

A vehicle 1 determines a future trajectory 3 at a first waypoint 2 at a first timepoint t₀. The trajectory 3 can be determined based on, e.g., the direction of the vehicle 1, the acceleration of the vehicle 1, the speed of the vehicle 1, the position of the vehicle 1, the yaw rate of the vehicle 1, map references, and/or a navigation device. In addition, a learning algorithm can be used, e.g., based on machine learning in order to determine trajectory 3. Moreover, trajectory 3 can be determined using dynamic models of the vehicle 1. The trajectory 3 corresponds to the expected route of the vehicle 1. In particular, the trajectory 3 corresponds to expected waypoints where the vehicle 1 is expected to be at specific timepoints. In addition, a tolerance range 4 is determined around the trajectory 3. The tolerance range 4 comprises waypoints, where the vehicle 1 will be at the next timepoints with a high probability. Low inaccuracies of the prediction are therefore considered by the tolerance range 4. In particular, the tolerance range 4 will become wider at later timepoints, since the trajectory 3 can be predicted less accurately.

The tolerance range 4 can in particular depend on the standard deviation of a position distribution of the expected waypoints. At timepoint t₀₊₁, the expected waypoints are close together and the standard deviation is low. Therefore, the tolerance range 4 is narrow at this timepoint. At timepoint t₀₊₄, the expected waypoints are further apart, so the tolerance range 4 also widens.

The trajectory 3 can be described by a polynomial, e.g., a third-order polynomial. It is also possible that the trajectory 3 comprise a number of waypoints. The tolerance range 4 can also be represented as a polynomial. Additionally, the vehicle 1 can send confidence information about the probability that the vehicle 1 is moving within the tolerance range 4 at a timepoint. For example, the vehicle 1 can at timepoint t₀ send that it is 85% likely to move within the tolerance range at the timepoint t₀₊₂. It is also possible that the confidence information be provided for a plurality of individual waypoints.

At timepoints t₀₊₁, t₀₊₂, t₀₊₃, the vehicle 1 checks whether it is within the tolerance range 4—i.e., whether the deviation from the trajectory 3 is low. The actual waypoints 2a, 2b, 2c are within the tolerance range 4 and thus the vehicle 1 does not send a new trajectory as the actual trajectory is covered by the first trajectory 3. A receiver (not shown) therefore needs no new trajectory information because the vehicle 1 is moving as expected.

At timepoint t₀₊₄, the vehicle 1 is outside the tolerance range 4, so the actual waypoint 2d is outside the tolerance range 4. The vehicle 1 is therefore no longer within the expected range. A receiver could consequently collide with the vehicle 1 as it does not expect the vehicle 1 to move away from the tolerance range 4. Therefore, a new second trajectory is estimated by an estimation device of the vehicle 1 at the timepoint t₀₊₄ and sent to a receiver. In particular, the new second trajectory can be regularly estimated, but only sent if the position of the vehicle deviates from the most recently sent trajectory. The second trajectory can be determined in a manner similar to the first trajectory 3 based on the direction, acceleration, speed, and/or position of the vehicle 1, as well as maps and/or a navigation device. The receiver can therefore again estimate where the vehicle 1 will be located at later timepoints. Given that the vehicle 1 sends the expected trajectory 3 immediately, a receiver can immediately determine the expected route of the vehicle 1 and need not calculate the route for this vehicle itself.

If the vehicle 1 is within the tolerance range 4 up to the end point 5 of the trajectory 3, then a receiver can no longer predict the route of the vehicle 1 because the timepoint when the last trajectory 3 was sent is too long ago and the vehicle 1 has not sent any further trajectory prediction. As a result, a new trajectory 3 can be sent no later than this timepoint. The number of waypoints that a receiver can predict thus decreases the longer the vehicle 1 has not sent a new trajectory 3. For example, to ensure a certain minimum number of predictable waypoints, a second trajectory can be sent no later than 1 second after the last transmission.

It is also possible for the vehicle 1 to check at any timepoint tₓ whether the future trajectory expected at that timepoint is also within the transmitted trajectory up to a definable timepoint t_{x+y}. Also, a deviation from the sent trajectory expected in the future can be a reason for resending the currently expected trajectory so that the receiver also has a correct prediction at least up to the timepoint t_{x+y}.

It is further conceivable that further triggers for a transmission event can occur during travel, e.g., an impending collision event or unusual driving behavior of the driver. In this case, the new trajectory 3 can be sent even if the vehicle has not yet moved away from the waypoints of the first predicted trajectory.

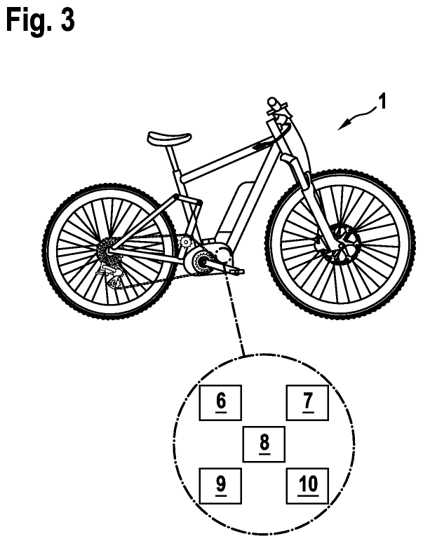

FIG. 3 shows in schematic form a vehicle according to one embodiment of the present disclosure.

The vehicle 1, in this case in the form of an e-bike, is designed to send messages to a receiver (not shown) during travel and comprises:
a first estimation device 6 designed to estimate a first trajectory of the vehicle 1,
a first sending device 7 designed to send trajectory information about the first trajectory to a receiver,
a determination device 8 designed to determine a deviation of an actual position of the vehicle 1 from a position predicted by the first trajectory,
a second estimation device 9 designed to estimate a second future trajectory, and
a second sending device 10 designed to send trajectory information about the second trajectory to the receiver if the deviation is greater than a threshold value.

Messages about an expected trajectory can be sent to a receiver by the vehicle 1 so that the receiver can adjust its own trajectory thereby.

In particular, the vehicle 1 is designed to perform steps S1 to S5 according to FIG. 1.

What is claimed is:

1. A method for sending messages from a vehicle to a receiver during travel by the vehicle, comprising:
estimating a first future trajectory of the vehicle;
sending trajectory information about the first trajectory to the receiver;
determining a deviation of an actual position of the vehicle from a position predicted by the first trajectory;
estimating a second future trajectory; and
sending trajectory information about the second trajectory to the receiver if the deviation is greater than a threshold value.

2. The method according to claim 1, wherein the trajectory information about the first and/or second trajectory comprises information about at least one possible future waypoint at which the vehicle can be located at least at one specific future timepoint.

3. The method according to claim 2, wherein the trajectory information about the first and/or second trajectory comprises confidence information for at least a portion of the possible future waypoints.

4. The method according to claim 1, wherein the first and/or second trajectory is described using one or multiple polynomials.

5. The method according to claim 4, wherein the first and/or second trajectory comprises a tolerance range described by polynomials.

6. The method according to claim 5, wherein the tolerance range is calculated based on a statistical characteristic of the future waypoints.

7. The method according to claim 6, wherein the determination of a deviation is performed based on a comparison of the actual position of the vehicle with waypoints described by the tolerance range.

8. The method according to claim 1, wherein the trajectory information about the second future trajectory is sent if more than a predefined period of time has elapsed since the trajectory information about the first trajectory was sent.

9. The method according to claim 1, wherein trajectory information about the second future trajectory is sent when the second future trajectory deviates from the first future trajectory.

10. The method according to claim 1, wherein information is transmitted about future directions, speeds, and/or accelerations of the vehicle.

11. The method according to claim 1, wherein the first and/or second trajectory is estimated based on a direction of the vehicle, an acceleration of the vehicle, a speed of the vehicle, a position of the vehicle, a yaw rate of the vehicle, based on dynamic models of the vehicle based on map information, and/or at least one learning algorithm.

12. A vehicle designed to send messages to a receiver during travel, comprising:
a first estimation device designed to estimate a first trajectory of the vehicle;
a first sending device designed to send trajectory information about the first trajectory to a receiver;
a determination device designed to determine a deviation of an actual position of the vehicle from a position predicted by the first trajectory;
a second estimation device designed to estimate a second future trajectory; and
a second sending device designed to send trajectory information about the second trajectory to the receiver if the deviation is greater than a threshold value.

13. The method according to claim 5, wherein the tolerance range is calculated based on a standard deviation of the future waypoints.

14. The method according to claim 1, wherein trajectory information about the second future trajectory is sent if the second future trajectory deviates from the first future trajectory within a predefined period of time.
